(19) United States
(12) Patent Application Publication
(10) Pub. No.: US 2018/0012241 A1
(43) Pub. Date: Jan. 11, 2018

(54) Customer Presence Detection

(71) Applicant: Wal-Mart Stores, Inc., Bentonville, AR (US)

(72) Inventors: Nicholaus A. Jones, Fayetteville, AR (US); Robert J. Taylor, Rogers, AR (US); Aaron J. Vasgaard, Rogers, AR (US); Matthew A. Jones, Bentonville, AR (US)

(21) Appl. No.: 15/643,691

(22) Filed: Jul. 7, 2017

Related U.S. Application Data
(60) Provisional application No. 62/359,988, filed on Jul. 8, 2016.

(51) Int. Cl. G06Q 30/02; G01V 3/12; G01S 13/89; G06Q 10/06; G01S 13/72

(52) U.S. Cl. CPC G06Q 30/0201; G06Q 10/06311; G01S 13/726; G01S 13/89; G01V 3/12

(57) ABSTRACT

In some embodiments, apparatuses and methods are provided herein useful to track customer presence and movement within a shopping facility. More specifically, reflections of non-visible electromagnetic (EM) waves can be analyzed to locate customers within an area and track customer movement over time. Maps of the area can be created at first and second times and compared with one another to determine differences.

### CROSS-REFERENCE TO RELATED APPLICATIONS

This application claims the benefit of U.S. 62/359,988, filed Jul. 8, 2016, which is hereby incorporated by reference herein in its entirety.

### TECHNICAL FIELD

This invention relates generally to customer tracking within a shopping facility.

### BACKGROUND

The distribution and location of items within a shopping facility can be important to a retailer to maximize sales. Shopping facilities have to decide where to place certain items based in part on popularity, type, and power supply needs, to name a few. Additionally, maintaining sufficient stock levels for products within the shopping facility can be important to prevent lost sales. Accordingly, any information on customer location and movement within the shopping facility can be very helpful.

### BRIEF DESCRIPTION OF THE DRAWINGS

Disclosed herein are embodiments of systems, apparatuses and methods pertaining to tracking customer presence and movement within a shopping facility. This description includes drawings, wherein:

FIG. 1 is a diagrammatic top plan view of a shopping facility in accordance with some embodiments.

FIG. 2 is diagrammatic side elevation view of an area within a shopping facility in accordance with several embodiments.

FIG. 3 is a diagrammatic map of an area within a shopping facility at a first time in accordance with some embodiments.

FIG. 4 is a diagrammatic map of the area within the shopping facility of FIG. 3 at a second time in accordance with several embodiments.

FIG. 5 is a graph in accordance with some embodiments.

FIG. 6 is a flowchart in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to track customer presence and movement within a shopping facility. More specifically, reflections of non-visible electromagnetic (EM) waves can be analyzed to locate customers within an area and track customer movement over time. Due to the nature of material composition, customers will absorb a higher percentage of the EM waves than the product displays or flooring. As such, the customers will appear differently on any given map than the fixtures within the facility. Maps of the area can be created at first and second times and compared with one another to determine differences. Any differences can likely be attributed to customers as the fixtures within the facility commonly are not moved frequently. Further, analysis of the maps can be used to create tasks to check on stock levels, check on the cleanliness of the area, and the like. By a further approach, analysis of the maps can be used to rearrange products or displays within the shopping facility to increase sales, decrease traffic, increase product visibility, and so forth.

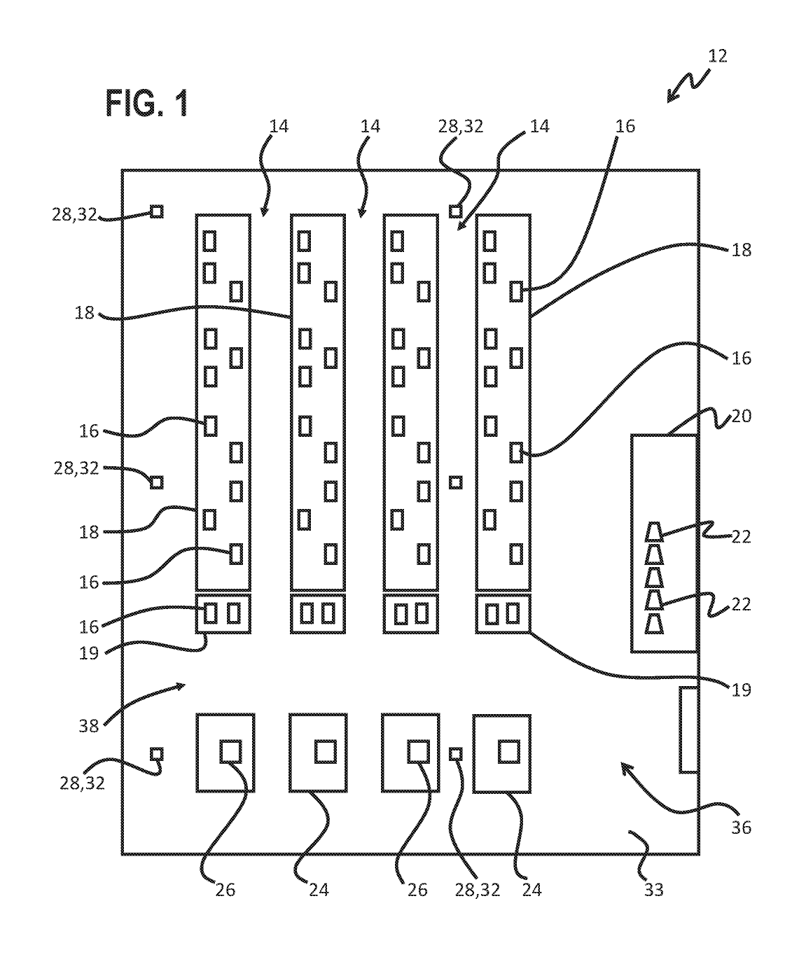

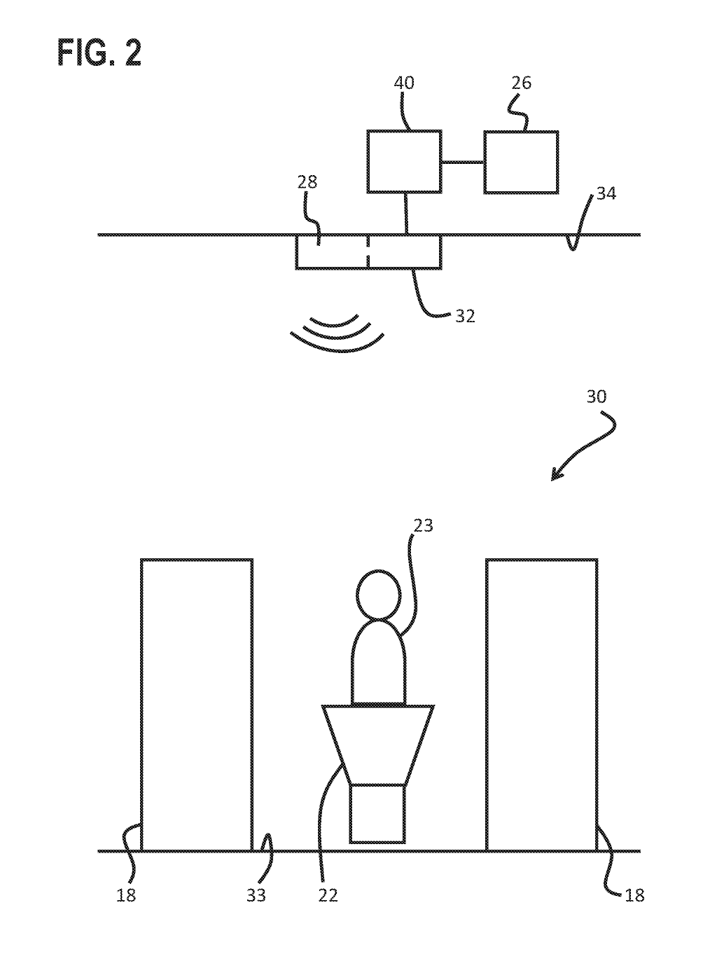

As illustrated in FIGS. 1 and 2, a shopping facility 12 can typically include a plurality of aisles 14 having products 16 disposed therealong on various displays 18, such as shelving units, coolers, and the like, and on feature locations 19, which can be located at the end of the aisles 14, in free-standing displays, or the like. A cart corral 20 is typically located near an entrance to the shopping facility 12 with carts 22 generally contained therein. As a customer 23 enters the shopping facility 12, the customer 23 can therefore get one of the carts 22 for the shopping trip. Thereafter, the customer 23 will travel through the shopping facility 12 collecting products 16 and proceed to one or more point-of-sale locations 24 having point-of-sale devices 26.

An EM wave generator 28 can be mounted within the shopping facility 12 and oriented to project non-visible EM waves, such as radio waves, infrared waves, or micro waves, into an area 30 within the shopping facility 12. The generator 28 can be configured to continuously emit EM waves or can be configured to emit EM waves at predetermined intervals, such as once per second, a multiple times per second, or multiple times per millisecond. Of course, the generator 28 can be configured as desired to emit EM waves more frequently or less frequently as desired or required for a particular application.

An EM wave reader or sensor 32 can further be mounted within the shopping facility 12 and oriented to receive reflections of the EM waves from the area 30. The generator and reader 28, 32 can be separate devices, in the same or separate housings, or can be incorporated into one device, such as a transceiver.

In a preferred form, the EM wave generator and reader 28, 32 can be mounted in or adjacent to a ceiling 34 of the shopping facility 12 so that the EM waves can be projected generally downwardly into the area 30. Of course, other locations and orientations can also be utilized as desired. Further, to track an entire customer area 36, an array 38 of EM wave generators and readers 28, 32 can be distributed throughout the customer area 36 of the shopping facility 12 to thereby track customer presence and movement within the individual areas 30 of the array 38. By one approach, the generators and readers 28, 32 can be spaced apart by about 50 feet or less. Of course, larger distances can also be utilized.

The reader or readers 32 can be coupled to a control circuit 40 configured to analyze and process the reflections received thereby. The readers 32 can be hardwired to the control circuit 40 or can be configured to communicate wirelessly therewith utilizing any suitable network or protocol. With the wireless communication approach, the imager can include a suitable transmitter or transceiver configured to send signals over the selected network or protocol. Additionally, the term control circuit as used herein refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 40 may be configured (for example, by using corresponding programming stored in a memory as will be well understood by those skilled in the art) to carry out one or more of the steps, actions, and/or functions described herein.

Objects with different material structures absorb the non-visible EM waves at different levels and thus can be distinguished from one another when the reflections are analyzed. For example, the product displays 18 can largely be made of metal, which reflects all or most of the EM waves. Customers 23, in comparison, are largely water, which absorbs a large amount of EM waves and therefor results in relatively fewer reflections than the product displays 18. Further, materials commonly used as flooring in shopping facilities reflect a higher percentage of EM waves than customers 23. As such, each item will appear differently, i.e., have a different received signal strength and distribution within a defined area, when the reflected EM waves are received at the EM wave reader 32 and analyzed by the control circuit 40. If desired, the fixtures with the shopping facility 12, including the product displays 18 and the flooring, can be treated to further differentiate from customers. For example, metal flakes, panels, and so forth can be applied, such as using paint or the like, adhered, or otherwise mounted thereto so that the fixtures reflect a higher percentage of EM waves. Additionally, the relative height of objects within the area 30 can be determined based on the time of reception or phase of the reflections at the reader 32 as compared to the generated EM waves and, thus, the distance that the EM waves traveled. This distance determination can be used to further distinguish between objects in the area 30, as the product displays 18 will generally be taller than customers 23, carts 22, and other objects within the area 30.

The control circuit 40 can create a map of the area 30 by analyzing the reflections received by the reader 32 and the signal strength thereof. More specifically, the control circuit 40 can produce a map or layout of the area 30 where each feature is identified by the signal strength of the reflections of the EM waves. The map can be further detailed by identifying a relative height of the features based on the reception time of the reflections. Accordingly, while a metal product display 18 and a metal cart 22 may have a similar reflection percentage, the roundtrip time of an EM wave traveling to the cart 24 will be longer than the roundtrip time of an EM wave traveling to the product display 18. So configured, the control circuit 40 can produce a map where each portion of the map has an associated signal strength, i.e., an amount of EM waves absorbed by the feature, and an associated height. The map can take any suitable form. For example, the received reflections can be left in signal form and compared to the generated EM signal. Alternatively, the received signals can be combined together to provide an overhead view of the facility 12 so that the relative strength of the distributed received signals can be compared together. The control circuit 40 can also separately analyze the readings of individual readers 32, combine the readings to create an overall determination for the facility 12, and so forth.

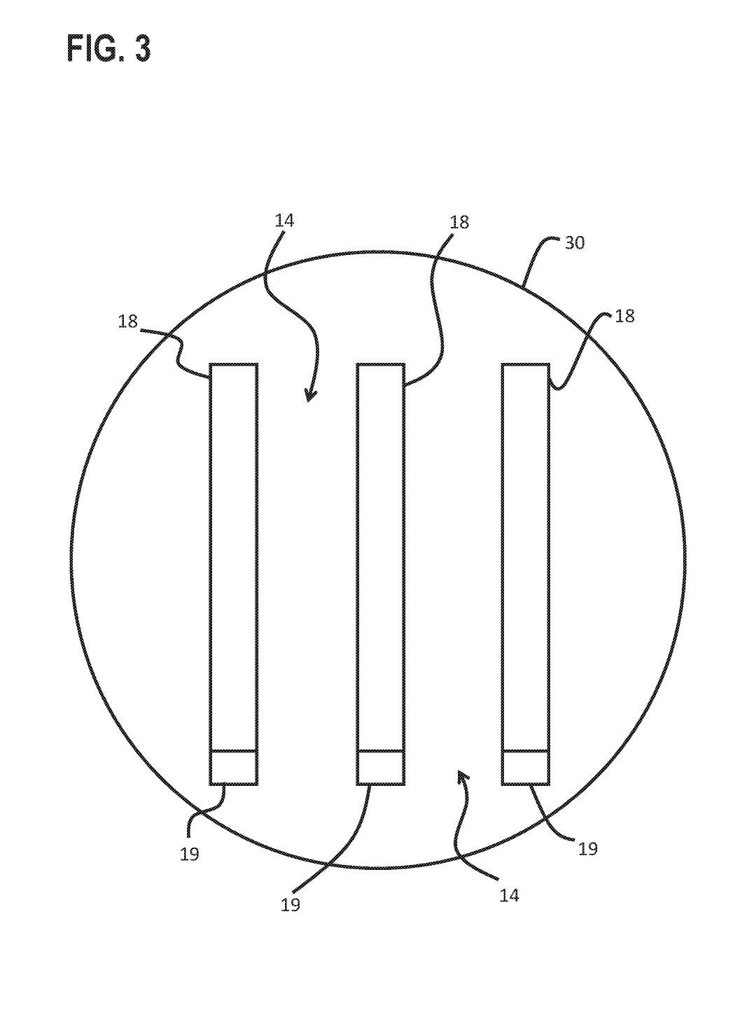

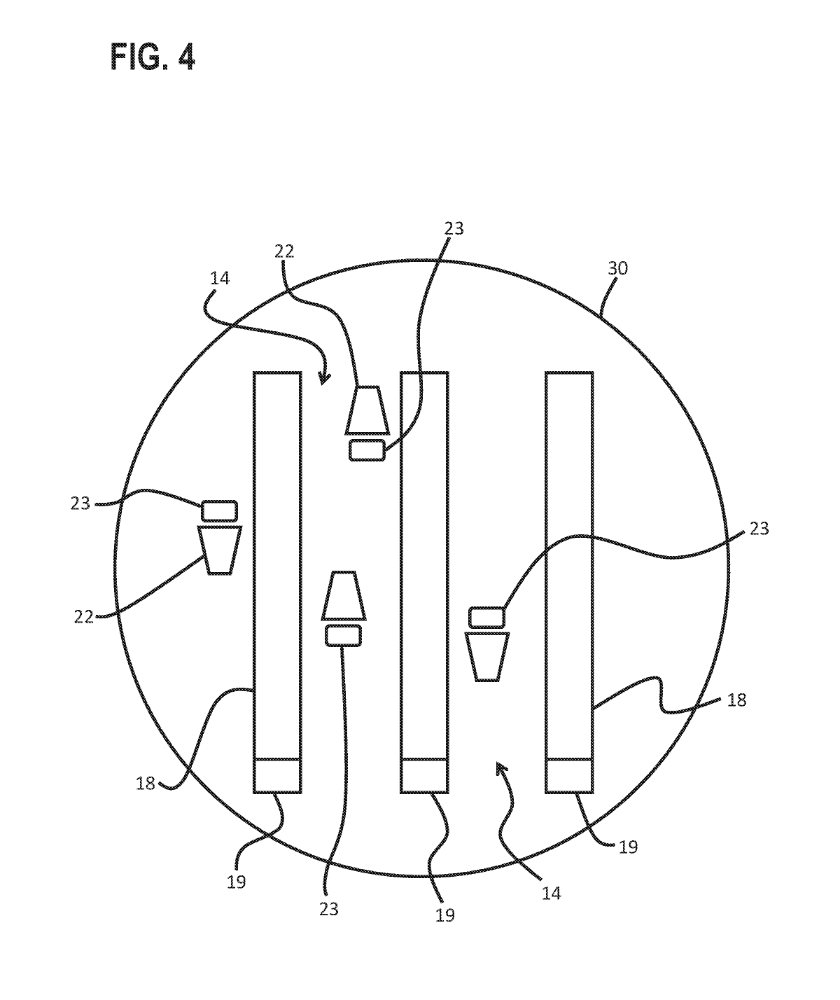

Moreover, the control circuit 40 can calibrate the system by creating a baseline map of the area 30 for subsequent comparison. In a preferred form, the baseline map can be a map of the area 30 without customers 23 present, as shown in FIG. 3. With this baseline map for comparison, any changes in subsequent maps will likely correspond to customers 23 within the area 30, as shown in FIG. 4, because the product displays 18 and floor 33 in the shopping facility 12 will generally not change over time. The baseline map can be established on command when no customers 23 are within the area 30 or can be established based on a prolonged period without activity, such as 5 minutes, 10 minutes, 15 minutes, or the like.

As discussed above, the control circuit 40 can analyze the reflections received at each reader 32 to determine whether one or more customers 23 are within the area. Further, the control circuit 40 can compare maps of the area 30 at different times to track customer movement, as shown in FIGS. 3 and 4. With the array 38 embodiment discussed above, the control circuit 40 can compile the maps of all the areas 30 within the customer area 36 to produce an overall map of the customer area 36 and the locations of customers 23 within the customer area 36 at sequential times.

By some approaches, the frequency and/or amplitude of the EM waves can be adjusted to refine the accuracy of the reflections and therefore identification of customers 23 within the area 30. By a first approach, the generator 28, which can be controlled by the control circuit 40, can modulate between frequencies and amplitude combinations so that the reader 32 receives reflections of a variety of EM waves. By a second approach, the control circuit 40 can analyze the reflections and based on the clarity of the map indicated by the reflections, adjust the frequency and/or amplitude of the EM waves generated by the generator 28.

The control circuit 40 can further determine whether there is a large amount of traffic within each area 30. In one example, a large amount of traffic can correspond to a predetermined number of customers 23, such as 10, 15, 25, 50, 100, or the like, within the area 30 in a predetermined time, such as 10 minutes, 15 minutes, 30 minutes, 60 minutes, 120 minutes, or the like. In another example, a large amount of traffic can be an increased percentage over an average level of traffic established over previous days or hours, such as 15%, 30%, 50%, and so forth.

If the control circuit 40 determines that the area 30 has had a large amount of traffic, the control circuit 40 can create a task for an associate to check out the area 30. Similarly, if the control circuit 40 determines that the area 30 has had a relatively small amount of traffic, the control circuit 40 can create a task for an associate to check out the area 30. The task in either situation can be directed to the associate checking stock levels for products 16 within the area 30, checking the cleanliness of the area 30, offering assistance to customers 23 in the area 30, or the like.

By a further approach, the control circuit 40 can receive sales data for the shopping facility 12, such as from the point of sale devices 26, and correlate the traffic tracked within the area or areas 30 back to the sales data. For example, if the control circuit 40 tracks a large amount of traffic within an area 30, but sales within the shopping facility 12 do not reflect a corresponding large amount of sales of products 16 within the area 30, the control circuit 40 can create a task to reevaluate the products 16 stocked in the area 30 to better take advantage of the traffic and increase sales, reevaluate pricing of the products 16 in the area 30, reevaluate the product assortment in the area 30, and so forth. The data can further be used to identify whether certain products may be difficult to find, whether certain products could be valuably relocated within the store, such as to a featured location 19, and the like.

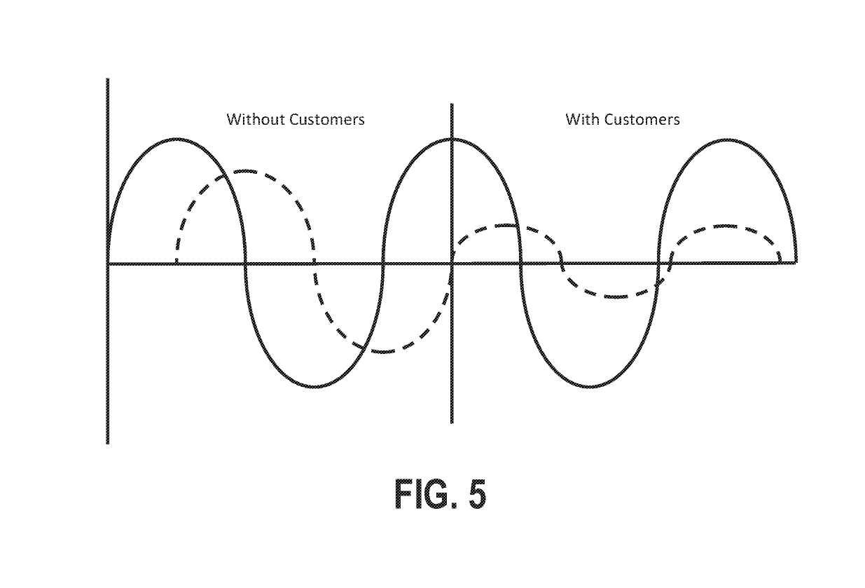

In one example, FIG. 5 illustrates a comparison of a signal of a generated EM wave and a signal of received reflections of the generated EM wave based on whether a customer is within the defined area. The left portion of the graph shows a large proportion of generated EM waves received as reflections within this defined area causing a relatively high amplitude as compared to the original generated signal. This indicates that the EM waves hit reflective surfaces or structures within the defined area, as discussed above. Further, the phase of the received reflections signal is offset, but regular with respect to the original generated signal. The right portion of the graph, however, shows a decreased proportion of generated EM waves received as reflections relative to the left portion causing a relatively low amplitude as compared to both the original generated signal and the left portion of the graph. This indicates that objects, such as customers, that absorb a significant portion of EM waves are present within the defined area. Further, the absorbent objects can cause the phase of the received reflections to be irregular with respect to the original generated signal as shown. The phase and amplitude of the received signal can therefore be utilized to identify different objects within the defined area. In the above example of setting a baseline reading without customers present, a drop-off in the proportion of received reflections of generated EM waves and/or an irregular phase as compared to the generated signal can be used to identify and track customer presence and movement within the defined area. Further, with an array of EM wave generators 28 and EM wave receivers disposed throughout the shopping facility 12, the system described herein can be utilized monitor customer movement within the facility to identify potential issues and maximum product placement and sales.

In some embodiments, a detection system for a shopping facility is described herein that includes an electromagnetic (EM) wave generator mounted within the shopping facility and configured to emit non-visible EM waves generally into an area within the shopping facility; an EM wave reader mounted within the shopping facility and configured to receive reflections of the non-visible EM waves from the area; and a control circuit operably coupled to the EM wave reader. The control circuit can be configured to: create a first map of the area including retail fixtures and any customers therein based on the reflections received by the EM wave reader at a first time; create a second map of the area including the retail fixtures and any customers therein based on the reflections received by the EM wave reader at a second time; and compare the first and second maps to detect changes within the area and thereby track customer movement within the area.

By several approaches, the control circuit can further be configured to create a task to send an associate to check on stock levels within the area in response to determining that traffic within the area is higher than a predetermined value.

By some approaches, the control circuit can further be configured to: receive product sales information for the shopping facility; and correlate the product sales information to the customer movement within the area.

By several approaches, the EM wave generator and the EM wave reader can include an array of EM wave generators and EM wave readers configured to cover an entire customer area of the shopping facility.

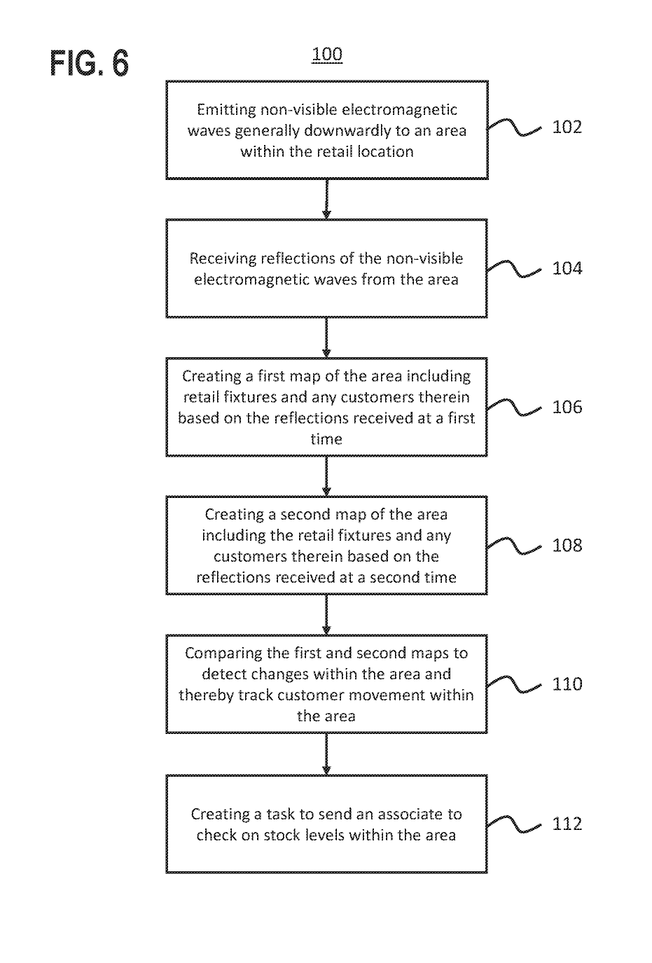

In several embodiments and as shown in FIG. 6, a method 100 for detecting within a shopping facility is described herein that includes emitting 102 non-visible electromagnetic (EM) waves generally downwardly to an area within the shopping facility with an EM wave generator; receiving 104 reflections of the non-visible EM waves from the area with an EM wave reader; creating 106 a first map of the area including retail fixtures and any customers therein with a control circuit based on the reflections received by the EM wave reader at a first time; creating 108 a second map of the area including the retail fixtures and any customers therein with the control circuit based on the reflections received by the EM wave reader at a second time; and comparing 110 the first and second maps with the control circuit to detect changes within the area and thereby track customer movement within the area.

By some approaches, the method can further include creating 112 a task to send an associate to check on stock levels within the area in response to determining that customer movement within the area is higher than a predetermined value.

By several approaches, the method can further include receiving product sales information for the shopping facility; and correlating the product sales information to the customer movement within the area.

By some approaches, emitting the non-visible EM waves generally downwardly to the area within the shopping facility with the EM wave generator can include emitting non-visible EM waves generally downwardly to an entire customer area of the shopping facility with an array of EM wave generators; and receiving the reflections of the non-visible EM waves from the area with the EM wave reader can include receiving reflections of the non-visible EM waves from the entire customer area with an array of EM wave readers. It is understood that in some embodiments, the method of FIG. 5 can be performed at least by any of the structures described herein and any other devices.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A detection system for a shopping facility, the system comprising:
an electromagnetic (EM) wave generator mounted within the shopping facility and configured to emit non-visible EM waves generally into an area within the shopping facility;
an EM wave reader mounted within the shopping facility and configured to receive reflections of the non-visible EM waves from the area;
a control circuit operably coupled to the EM wave reader and configured to:
create a first map of the area including retail fixtures and any customers therein based on the reflections received by the EM wave reader at a first time;
create a second map of the area including the retail fixtures and any customers therein based on the reflections received by the EM wave reader at a second time; and
compare the first and second maps to detect changes within the area and thereby track customer movement within the area.

2. The system of claim 1, wherein the EM wave generator and the EM wave reader comprise an EM transceiver.

3. The system of claim 1, wherein the EM wave generator and the EM wave reader utilize radio waves.

4. The system of claim 1, wherein the EM wave generator and the EM wave reader utilize micro waves.

5. The system of claim 1, wherein the first map comprises a first map of the area with no customers present.

6. The system of claim 1, wherein the control circuit is further configured to create a task to send an associate to check on stock levels within the area in response to determining that traffic within the area is higher than a predetermined value.

7. The system of claim 1, wherein the control circuit is further configured to:
receive product sales information for the shopping facility; and
correlate the product sales information to the customer movement within the area.

8. The system of claim 1, wherein the EM wave generator and the EM wave reader comprise an array of EM wave generators and EM wave readers configured to cover an entire customer area of the shopping facility.

9. The system of claim 1, wherein the EM wave generator is configured to emit non-visible EM waves at least every second.

10. A method for detecting within a shopping facility, the method comprising:
emitting non-visible electromagnetic (EM) waves generally downwardly to an area within the shopping facility with an EM wave generator;
receiving reflections of the non-visible EM waves from the area with an EM wave reader;
creating a first map of the area including retail fixtures and any customers therein with a control circuit based on the reflections received by the EM wave reader at a first time;
creating a second map of the area including the retail fixtures and any customers therein with the control circuit based on the reflections received by the EM wave reader at a second time; and
comparing the first and second maps with the control circuit to detect changes within the area and thereby track customer movement within the area.

11. The method of claim 10, wherein emitting the non-visible EM waves and receiving reflections of the non-visible EM waves comprises a transceiver emitting the non-visible EM waves and receiving the reflections of the non-visible EM waves.

12. The method of claim 10, wherein emitting the non-visible EM waves comprises emitting radio waves.

13. The method of claim 10, wherein emitting the non-visible EM waves comprises emitting micro waves.

14. The method of claim 10, wherein creating the first map comprises creating a first map of the area with no customers present.

15. The method of claim 10, further comprising creating a task to send an associate to check on stock levels within the area in response to determining that customer movement within the area is higher than a predetermined value.

16. The method of claim 10, further comprising:
receiving product sales information for the shopping facility; and
correlating the product sales information to the customer movement within the area.

17. The method of claim 10, wherein emitting the non-visible EM waves generally downwardly to the area within the shopping facility with the EM wave generator comprises emitting non-visible EM waves generally downwardly to an entire customer area of the shopping facility with an array of EM wave generators; and receiving the reflections of the non-visible EM waves from the area with the EM wave reader comprises receiving reflections of the non-visible EM waves from the entire customer area with an array of EM wave readers.

18. The method of claim 10, wherein emitting the non-visible EM waves comprises emitting non-visible EM waves with the EM wave generator at least every second.
